(19) United States
(12) Patent Application Publication
(10) Pub. No.: US 2006/0026019 A1
(43) Pub. Date: Feb. 2, 2006

(54) System and method for measuring communication-system infrastructure usage

(75) Inventors: Vincent Sethi, Chandlers Ford (GB); Philip J. DiStefano, Scarsdale, NY (US); Thomas J. Connelly, Wantagh, NY (US)

Correspondence Address: DOCKET ADMINISTRATOR;LOWENSTEIN SANDLER PC, 65 LIVINGSTON AVENUE, ROSELAND, NJ, 07068, US

(73) Assignee: JP Morgan Chase Bank, New York, NY (US)

(21) Appl. No.: 11/113,700

(22) Filed: Apr. 25, 2005

Related U.S. Application Data
(60) Provisional application No. 60/591,460, filed on Jul. 27, 2004.

(51) Int. Cl. G06Q 99/00

(52) U.S. Cl. 705/1

(57) ABSTRACT

In a communication-system infrastructure usage measurement system and related methods with minimal overhead, message usage statistics are aggregated at a communication-channel level by emitter programs before sending them to a collector program upon an occurrence of an event. An example of an event is an expiration of a predetermined interval. In between event occurrences, message usage statistics are aggregated, and a summary message is transmitted to the collector at the next event occurrence. The collector program compiles the statistics and may generate billing information from the compiled statistics. The billing information may include charges associated with an entity that uses the infrastructure.

### CROSS-REFERENCE TO RELATED APPLICATION

This application claims the benefit of U.S. Provisional Application No. 60/591,460, filed Jul. 27, 2004, the entire disclosure of which is hereby incorporated herein by reference.

### FIELD OF THE INVENTION

This invention relates to measuring a usage of a communication-system infrastructure. In particular, this invention pertains to gathering message statistics from a communication-system infrastructure and generating billing information based upon the gathered statistics.

### BACKGROUND OF THE INVENTION

Setting up an infrastructure that facilitates communication between programs, or applications, on remotely connected computers is expensive. Such infrastructures require expensive hardware and communication lines and complex software. Typically, the users who take advantage of the infrastructure do not contribute to the initial capital outlay required to set up the infrastructure. Accordingly, an organization desiring to set up the infrastructure commonly has to finance the initial capital outlay on its own. In order to recoup the initial capital outlay, as well as maintenance costs, the organization may charge fees to the users of the infrastructure. For example, the organization may charge its users based upon the number of messages sent across the infrastructure and/or the size of the messages sent.

Traditional schemes for recouping costs and/or generating revenue from an infrastructure include message tracking systems that have a secondary purpose of reporting on usage of the infrastructure. In particular, these conventional schemes log detailed statistics for each and every message that is transmitted through the infrastructure, such as who sent the message, where the message is going, how large the message is, when the message was sent, etc. With each message, this tracking data is recorded and sent to a central repository that maintains a master log of every message transmitted through the infrastructure. This massive historical log is then parsed to retrieve usage statistics for each billable entity, which may be users of the infrastructure or organizations that the users work for. From the usage statistics, bills may be generated and sent to each billable entity requesting payment for the billable entity's use of the infrastructure.

A drawback of the conventional schemes is that a tremendous amount of overhead is required to generate the billing information, especially if the tracking functions are not desired. In particular, the conventional schemes generate a tracking message for each actual message transmitted through the infrastructure. In essence, the tracking functionality produces a 100% overhead in infrastructure resources. In cases where only billing information generation is desired and the message tracking functionality is not, the 100% overhead becomes even more intrusive to the infrastructure. Stated differently, up to half of the infrastructure resources may be required to generate billing information, which limits the amount of actual traffic the infrastructure can support and reduces the amount of billable messages that can be sent through the infrastructure.

Accordingly, a need in the art exists for a “light-weight” infrastructure usage monitoring system that can generate billing information with reduced impact on infrastructure resources.

### SUMMARY OF THE INVENTION

This problem is addressed and a technical solution is achieved in the art by a system and a method for measuring communication-system infrastructure usage according to the present invention. According to an embodiment of the present invention, an emitter program monitors messages that pass through at least one communication channel in the infrastructure. The emitter program generates a statistical summary of the monitored messages. The statistical summary may include at least an aggregate of a number of messages sent and/or received and an aggregate of an amount of data transmitted through the at least one communication channel by a billable entity. The statistical summary also may include such aggregate information for each of a plurality of billable entities. A billable entity may include a program associated with a user of the infrastructure. A user of the infrastructure may include an individual and/or an organization.

Upon an occurrence of an event, the emitter program transmits a summary message including the statistical summary to a collector program. The event may be a passage of a predetermined time, an expiration of a predetermined interval, a monitoring of a certain number of messages that pass through the monitored channel(s), a monitoring of a certain amount of data that passes through the monitored channel(s), a monitoring of a certain number of messages and/or an amount of data that passes through the monitored channel(s) from a particular billable entity, a ceasing of operation of one or more of the monitored channel(s), a receipt of a message prompting transmission of the summary message, and/or any other event. The emitter program may delete its statistical summary every time a summary message is transmitted to the collector program, thereby reducing memory requirements of the emitter program and eliminating redundancy of statistical information. The collector program combines the statistical summary included in the summary message with other summary messages received from other emitter programs. The collector program outputs the combined statistical summaries, which may be used to generate billing information; to perform infrastructure resource planning; to perform marketing tasks, such as advertising the amount of system usage or sending targeted advertisements to entities based upon their usage; or for other purposes used by an organization to improve efficiency, reduce operating costs, or increase revenue. The outputting may be to a computer-accessible memory.

According to an embodiment of the present invention, the collector program may generate billing information based at least upon the statistical summary included in the received summary message. The billing information may include an amount to be billed to a billable entity based upon at least one of a total number of messages transmitted by the billable entity, an amount of data transmitted by the billable entity, whether messages transmitted by the billable entity were encrypted or persistent, and when messages were transmitted by the billable entity.

According to another embodiment of the present invention, each of a plurality of emitter programs monitors messages that pass through at least one communication channel. Upon the occurrence of an event, which may be the same or different between emitter programs, a corresponding emitter program transmits a summary message to the collector program. The collector program compiles the statistical summaries from each of the received summary messages and outputs the compiled statistical summaries. In addition or in the alternative, the collector program may generate billing information from the compiled statistical summaries.

According to yet another embodiment of the present invention, an emitter program is executed by a server computer that routes incoming and outgoing messages to their proper destinations. The emitter program monitors a communication channel used by the server computer to route messages. A collector program is executed by a collection computer communicatively connected to the server computer and, optionally, an accounting system. The emitter program generates a statistical summary of the messages that pass through its channel. Upon the occurrence of an event, the emitter program transmits a summary message including the statistical summary to the collector program. The collector program combines the statistical summary included in the summary message with other summary messages received from other emitter programs. The collector program outputs the combined statistical summaries and/or may generate billing information based at least upon the combined statistical summaries. In the scenario where the collector program generates billing information, the collector program may output the billing information to the accounting system.

According to a further embodiment of the present invention, a plurality of collector programs may be provided. Each collector program may receive summary messages from its own set of emitter programs. The collector programs compile the statistical summaries they receive from their emitter programs and transmit their own summary messages including compiled statistical summaries to a master collector program. The master collector program compiles the statistical summaries it receives from the collector programs. The master collector program outputs its compiled statistical summary and/or may generate billing information based at least upon its compiled statistical summary.

According to another embodiment of the present invention, a hierarchy of collector programs are provided and statistical summaries are compiled at each level and transmitted to a collector program at the next higher level in the hierarchy. The collector program at the root of the hierarchy generates an overall summary of statistical information and generates billing information based at least upon the overall summary. By providing a hierarchy of collector programs, infrastructure traffic and overhead may be further reduced over the conventional schemes.

### BRIEF DESCRIPTION OF THE DRAWINGS

The present invention will be more readily understood from the detailed description of preferred embodiments presented below considered in conjunction with the attached drawings, of which:

FIG. 1 illustrates a system for measuring communication-system infrastructure usage, according to an embodiment of the present invention;

FIG. 2 illustrates an arrangement of emitter programs, according to an embodiment of the present invention;

FIG. 3 illustrates an interaction between emitter programs and a collector program according to an embodiment of the present invention;

FIGS. 4A, 4B, 5A, and 5B illustrate flow charts summarizing methods for measuring communication-system infrastructure usage, according to an embodiment of the present invention; and

FIG. 6 illustrates a hierarchy of collector programs, according to an embodiment of the present invention.

It is to be understood that the attached drawings are for purposes of illustrating the concepts of the invention and may not be to scale.

### DETAILED DESCRIPTION OF THE INVENTION

The present invention provides a communication-system infrastructure usage measurement system with minimal overhead. According to an embodiment of the present invention, message usage statistics are aggregated at a communication-channel level before sending them to a collector program, which compiles the statistics and, optionally, may generate billing information from the compiled statistics. Contrary to conventional schemes, a message-usage-statistics message is not generated and transmitted for every message, but is transmitted upon the occurrence of an event, which may be, among other things, an expiration of a predetermined interval. In between event occurrences, message usage statistics are aggregated at the channel level, and a summary message is transmitted to the collector program at the next event occurrence. Although the measurements, or statistics, generated by embodiments of the present invention often are described as being used to generate billing information, such measurements may be used for other purposes, such as infrastructure planning, marketing, load balancing, efficiency improvement, and cost reduction, etc. Examples of marketing may include advertising the amount of system usage or targeted advertising to entities based upon their amount of system usage.

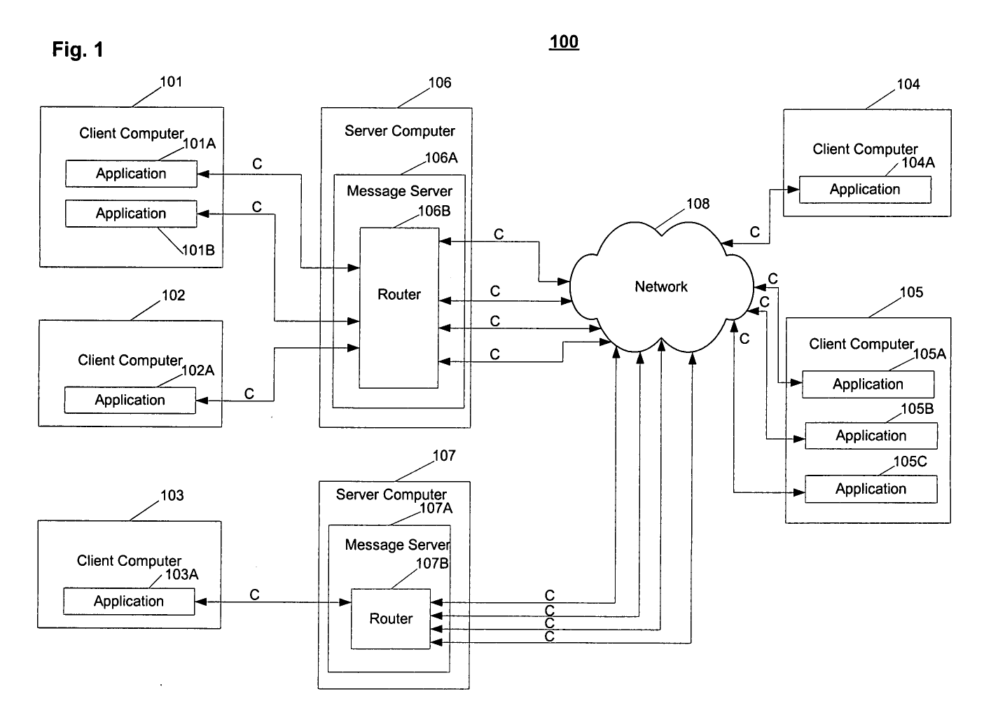

FIG. 1 illustrates an overview of a system 100 for measuring communication-system infrastructure usage, according to an embodiment of the present invention. Messages (not shown) are transmitted between client computers 101 to 105 through server computers 106, 107 via channels C. In particular, messages are transmitted between applications 101A, 101B, 102A, 103A, 104A, 105A, 105B, 105C executed by their associated client computers 101 to 105 through the server computers 106, 107 via the channels C. The channels C may traverse a network 108, such as the Internet, an intranet, or another network. The channels C are communicative connections. In an embodiment of the present invention, the channels C are provided in accordance with the channels used for transmitting messages according to IBM's Websphere MQ product, which is known in the art. “Websphere” is a registered trademark of the International Business Machines Corporation.

The phrases “communicative connection” and “communicatively connected” are intended to include any type of connection, whether wired (such as an electronic and/or optical and/or other physical connection), wireless, or both, between devices and/or programs in which data may be communicated. Further, these phrases are intended to include a connection between devices and/or programs within a single computer, a connection between devices and/or programs located in different computers, or a connection between devices not located in computers at all. The term “computer” is intended to include any data processing device, such as a desktop computer, a laptop computer, a mainframe computer, a personal digital assistant, a Blackberry, and/or any other device for processing data, and/or managing data, and/or handling data, whether implemented with electrical and/or magnetic and/or optical and/or biological components, or otherwise.

Message-routing functionality is provided by the server computers 106, 107. Such functionality may be provided by message server applications 106A, 107A executed by the server computers 106, 107, respectively. The message server applications 106A, 107A include router programs 106B, 107B, respectively, that route messages from a source client computer to a destination client computer via the channels C. For example, a message from the application 101A to the application 105C originates from the application 101A, is transmitted to the router program 106B, through the network 108, and to the application 105C. A message from the application 101A to the application 102A originates from the application 101A, is transmitted to the router program 106B, and then to the application 102A. A message from the application 101A to the application 103A originates from the application 101A, is transmitted to the router program 106B, through the network 108 to the router program 107B, and then to the application 103A.

Although not shown, one or more server computers similar to the server computers 106, 107 may be located within the network 108 and/or between the client computers 104, 105 and the network 108. In this situation, messages destined for the client computers 104, 105 will pass through such server computers on the way to their destination. On the other hand, messages originating from the client computers 104, 105 will pass through such server computers, which will then route the messages to the server computer 106 and/or the server computer 107 that will be able to forward the message(s) to the correct destination.

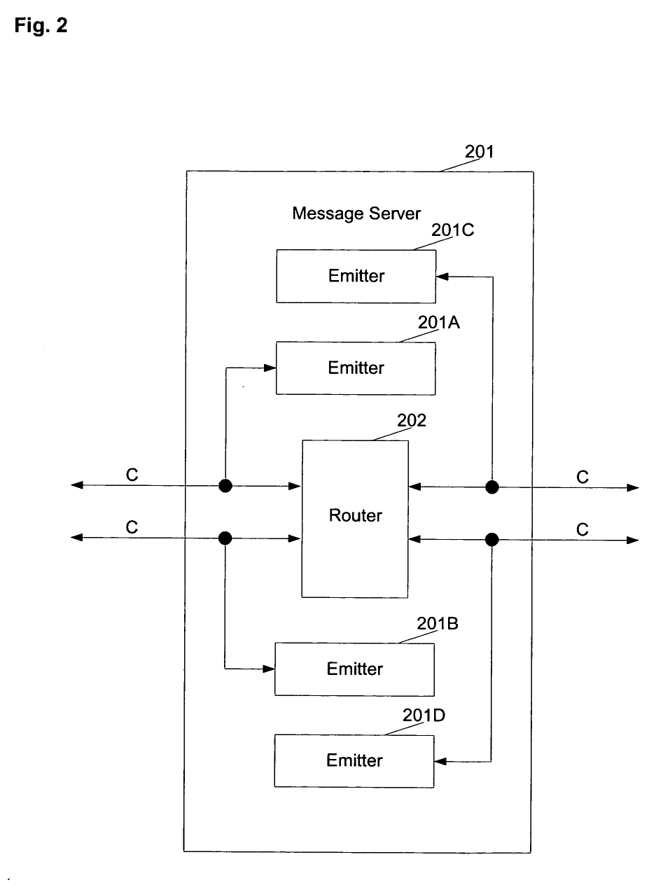

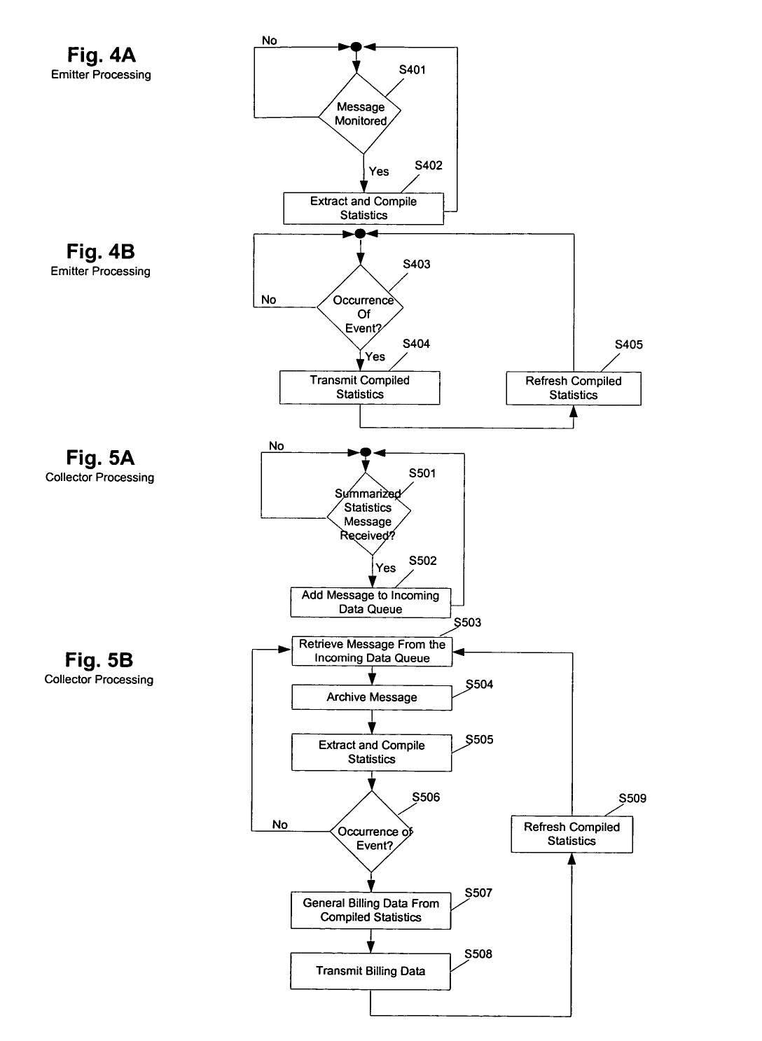

FIG. 2 illustrates an arrangement of emitter programs, according to an embodiment of the present invention, and will be described in conjunction with FIGS. 4A and 4B. A message server application 201, which illustrates the message server applications 106A and 107A in FIG. 1 with more detail, executes “emitter” programs 201A, 201B, 201C, 201D, each of which monitors messages propagating through a channel C. Although FIG. 2 illustrates the emitter programs 201A to 201D within the message server 201, one skilled in the art will appreciate that the emitter programs 201A to 201D may be executed independently, in conjunction with, or as part of the message server application 201. According to an embodiment of the present invention, the emitter programs 201A, 201B, 201C, 201D, for example, are input/output callback functions, examples of which are channel exits according to Websphere MQ, which is known in the art.

Optionally, emitter programs may be provided to monitor channels only on one side of the router program 202. For example, emitter programs 201A and 201B may be provided without the emitter programs 201C and 201D, or vice versa. Although shown in FIG. 2 as monitoring a single channel, the emitter programs 201A, 201B, 201C, 201D, for example, may monitor more than one channel.

At step S401 in FIG. 4A, each of the emitter programs 201A, 201B, 201C, 201D, for example, separately wait for a message to be transmitted through their monitored channel. Upon receipt of a message, the pertinent emitter program extracts and compiles statistics from the message, such as identifying the source entity of the message, the destination entity of the message, incrementing a total message counter associated with the source entity and/or the destination entity, adding the size of the message (e.g. number of bytes in the message) to a total-amount-of-data-transmitted counter associated with the source entity and/or the destination entity, a time of day associated with the message, etc. Upon completion of statistics compilation at step S402, the emitter program returns to message monitoring at step S401.

One skilled in the art will appreciate that any number and/or type of statistics may be compiled by the emitter programs, and that the invention is not limited to any particular metrics. For example, the statistical summary may include, without limitation, at least one of: a total number of messages transmitted by an entity through the monitored channel, an amount of data transmitted by the entity through the monitored channel, a number of messages transmitted by the entity through the monitored channel that were encrypted, an amount of data transmitted by the entity through the monitored channel that was encrypted, a number of messages transmitted by the entity through the monitored channel that were persistent, an amount of data transmitted by the entity through the monitored channel that was persistent, a number of messages transmitted by the entity through the monitored channel during a predetermined interval (such as, without limitation, peak hours between 9:00AM to 5:00PM), and an amount of data transmitted by the entity through the monitored channel during a predetermined interval. Further, the emitter programs may be configured to monitor how efficiently client applications 101A, 101B, 102A, 103A, 104A, 105A, 105B, 105C, for example, operate. For instance, the emitter programs may monitor how efficiently client applications transmit messages. In the case of MQ messages, client applications execute an “MQ Connect” function call that opens a connection with a message queue. Once the connection is open, the client application adds its message(s) to the message queue for transmission and then closes the connection. An inefficient client application may execute an MQ Connect function call for every message it transmits, instead of transmitting a plurality of messages with each MQ Connect function call. Because each MQ Connect function call places a strain on resources, it may be desirable to know which client applications are inefficient so that corrective action may be taken.

The processing outlined in FIG. 4B may occur independently from and simultaneously to the processing described with respect to FIG. 4A. With reference to FIG. 4B, the emitter programs 201A, 201B, 201C, 201D, for example, separately monitor whether an event occurs, as shown at step S403. In other words, the statistical summary prepared at step S402 for each message is generated until an occurrence of an event. Events may include, without limitation, at least one of a passage of a predetermined time, an expiration of a predetermined interval (such as, without limitation, a one- or two-hour interval), a monitoring of a certain number of messages that pass through the monitored channel, a monitoring of a certain amount of data that passes through the monitored channel, a monitoring of a certain number of messages and/or an amount of data that passes through the monitored channel from an entity, a ceasing of operation of the monitored channel, a receipt of a message prompting transmission of the summary message, or any other event. Examples of an entity include, without limitation, a program involved in the transfer of a message or a user associated with a program involved in the transfer of a message. A user may be an individual and/or an organization.

The emitter programs, 201A, 201B, 201C, 201D, for example, may be associated with the same or different events. Further, the events may be configured to occur at the same or different times, depending upon the nature of the event. Further still, an emitter program may have multiple events. For example, the events for the emitter program 201A may be the expiration of a two hour interval and a receipt of one thousand messages from a single entity, while the emitter program 201B may be associated with a single event, which may be the passage of 11:30 PM. Alternatively, all emitter programs 201A, 201B, 201C, 201D may have the same event, which may be the passage of ten gigabytes of data through their respectively monitored channels, for example.

Upon the occurrence of an event, at step S403, the emitter program 201A, 201B, 201C, or 201D associated with the event transmits the summarized statistics to a collector program, at step S404. Upon transfer of the summarized statistics, the emitter program may delete its summarized statistics from local memory, at step S405, and begin generating a new batch of summarized statistics until the next event occurs. By deleting the summarized statistics from local memory every time they are transferred, memory requirements for the emitter programs are reduced, thereby further reducing infrastructure resource overhead.

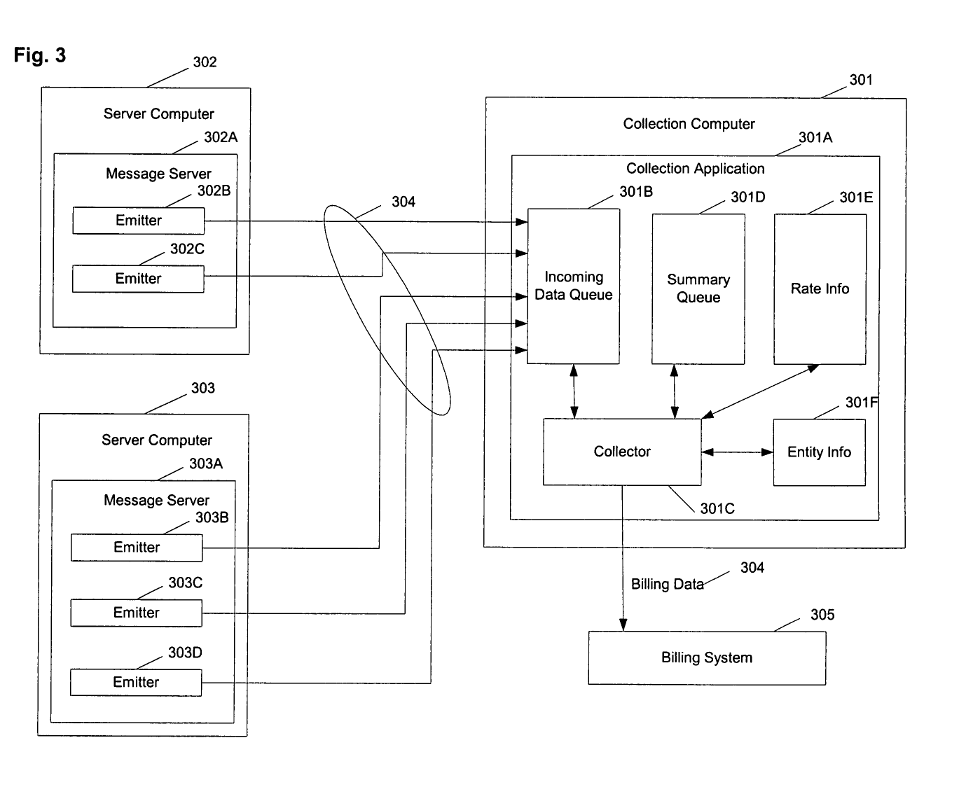

FIG. 3 illustrates an example of the communication between emitter programs 302B, 302C, 303B, 303C, 303D and a collector program 301C and will be described in conjunction with the flow charts of FIGS. 5A and 5B. The emitter programs 302B, 302C may be executed by a message server program 302A, which, in turn, is executed by a server computer 302. The emitter programs 303B, 303C, 303D may be executed by a message server program 303A, which, in turn, is executed by a server computer 303. The server computers 302, 303 are similar to the server computers 106, 107, 201 described with reference to FIGS. 1 and 2. Accordingly, although not shown, the server computers 302, 303 include a router, such as the routers 106B, 107B in FIG. 1, and channels C that are monitored by the emitter programs 302B, 302C, 303B, 303C, 303D. The collector program 301C may be executed by a collection application 301A, which, in turn, may be executed by a collection computer 301. The collection computer 301 is communicatively connected to the server computers 302 and 303.

As shown at step S501 in FIG. 5A, the collection application 301A monitors for incoming summarized statistics messages 304 from the emitter programs 302B, 302C, 303B, 303C, 303D. When a summarized statistics message 304 is received, it is stored, at step S502, in an incoming data queue 301B, which may be a first-in-first-out queue stored in a computer-accessible memory that is both readable and writable. The phrase “computer-accessible memory” is intended to include any computer-accessible data storage device, whether volatile or nonvolatile, electronic, magnetic, optical, or otherwise. An example of the incoming data queue 301B is shown in Table I.

TABLE I

| Source of Summarized | | Total Number |
|---|---|---|
| Statistics | Entity ID | of Messages |
| Emitter 302B | E1 | 5 |
| Emitter 302C | E1 | 5 |
| Emitter 303B | E2 | 8 |
| Emitter 303C | E2 | 12 |
| Emitter 303D | E3 | 25 |

The “Source of Summarized Statistics” column identifies which emitter program transmitted the summarized statistics message described by the corresponding row in Table I. The “Entity ID” column identifies the entity for which the summarized statistics apply. In this case, only one summarized statistic is illustrated with the “Total Number of Messages” column. For example, the first non-header row of Table I illustrates that a summarized statistics message was received from the emitter program 302B, that the statistics pertain to an entity “E1,” which may, for example, be a company “Company X,” and that the entity E1 transmitted five messages between the last two events (which is when the emitter program compiled the statistics reflected in the relevant summarized statistics message).

The data in Table I is simplified for the purposes of clarity. One skilled in the art will appreciate, however, that the summarized statistics messages shown in Table I may include other metrics besides or in place of the total number of messages. Further, the “Source of Summarized Statistics” and “Entity ID” columns illustrate in a simplified manner, one possible way of identifying the summarized statistics received from the emitter programs 302B, 302C, 303B, 303C, 303D.

In addition to the processing described with reference to FIG. 5A, the collection application 301A may execute processes to ensure that the emitter programs 302B, 302C, 303B, 303C, 303D are operating correctly. For example, the collection application 301A may be aware of all existing emitter programs 302B, 302C, 303B, 303C, 303D and their typical summarized statistics message transmission schedules. If the collection application 301A fails to receive one or more expected summarized statistics messages from the emitter programs 302B, 302C, 303B, 303C, 303D, an alert may be raised indicating a possible emitter program failure so that debugging processes can be initiated. One skilled in the art will appreciate that other techniques for ensuring the proper operation of the emitter programs 302B, 302C, 303B, 303C, 303D, for example, may be used.

Independent of the processing summarized in FIG. 5A, the processing illustrated in FIG. 5B occurs. At step S503, a collector program 301C executed as part of the collection application 301A retrieves a message from the incoming data queue 301B. At step S504, which is optional, the collector program 301C may archive the message in an archive, or “summary queue” 301D, which is a computer-accessible memory. At step S505, the collector program 301C extracts the statistics from the message retrieved at step S503 and aggregates them with statistics extracted from other messages retrieved from the incoming data queue 301B. For example, after retrieving the last message in the last row of Table I, the compiled statistics generated at step S505 may appear as shown in Table II.

TABLE II

| Entity ID | Total Number of Messages |
|---|---|
| E1 | 10 |
| E2 | 20 |
| E3 | 25 |

At step S506, the collector program 301C determines whether an event has occurred, such as an elapsing of a predetermined interval. For example, if the collection application 301A is to generate billing information monthly, the event may be an elapsing of a one-month period. If the event has not occurred, the collector program 301C returns to step S503 to retrieve another message from the incoming data queue 301B.

If the event has occurred, at step S506, billing data 304 may be generated. In order to generate the billing information, at step S507, the collector program 301C may reference rate information 301E, which includes information specifying charges associated with usage of the system 100. An example of the rate information 301E is shown in Table III.

TABLE III
Charge per Message
$1

The example rate information 301E in Table III is simplified for purposes of clarity to illustrate the concepts of the invention. One skilled in the art will appreciate, however, that the rate information 301E may contain other information, depending upon the statistics recorded by the emitter programs 302B, 302C, 303B, 303C, 303D. For instance, if the emitter programs record an amount of data transferred, the rate information 301E may include a cost per byte metric. If the emitter programs record a time of day that a message is transmitted, the rate information 301E may include a factor by which a cost per message metric or a cost per byte metric is multiplied depending upon the time of day of message transmission. For example, messages sent and/or received during peak hours may be charged double what is shown in Table III. Other ways to charge for usage of the system 100 may include higher or lower charges based upon client application efficiency, such as the number of MQ Connect function calls placed, for particular message destinations, for encrypted messages, for persistent messages, or for multi-destination messages. A persistent message is one that is retained by the collection application 301A indefinitely or for a period of time for archival purposes or in case the retained message needs to be resent to one or more destinations if the message fails to be successfully transmitted. A multi-destination message is a message that is transmitted to more than one destination. An example of a multi-destination message is a broadcast message that is transmitted to all destinations in a group of destinations. One skilled in the art will appreciate that the invention is not limited to the statistics gathered by the emitter programs or the manner in which entities are charged for their usage of the system 100.

The $1/message charge in Table III is an example only. In practice, a small fraction of a cent may be charged per message or per group of bytes based upon the large number of messages and large amount of data transmitted through the system 100.

In order to generate the billing information, at step S507, the collector program 301C also may reference entity information 301F, which includes information pertaining to the entities that use the system 100. Table IV illustrates an example of the entity information 301F, in accordance with the example of the previous tables.

TABLE IV

| Entity ID | Entity Name | Entity Address | Entity Account # |
|---|---|---|---|
| E1 | XYZ Company | Address 1 | 1234 |
| E2 | LOB X | Address 2 | 2345 |
| E3 | LOB Y | Address 3 | 3456 |

As shown in Table IV, entity ID E1 is associated with the XYZ company, which may be an entity separate from the entity operating the system 100. Entity ID E2 is associated with a line of business (“LOB”) “X” which may be a department or division within the entity operating the system 100. For example, an organization may develop its own infrastructure, such as the system 100, and charge its own lines of businesses for using the infrastructure in order to recoup the costs of developing and maintaining the infrastructure. At the same time, the organization that developed the infrastructure, e.g. the system 100, may allow external parties to use the infrastructure and charge them for using it. In this situation, the organization that operates the infrastructure may charge external parties more for using the infrastructure than it charges its own lines of businesses. Also as shown in Table IV, the entity information 301F may include address and account number information associated with each entity that is able to use the system 100. “Address1,” “Address2,” and “Address3” are intended to represent a complete address for each entity. One skilled in the art will appreciate that Table IV is a simplified example of the entity information 301F, and that the invention is not limited to the types of data included in the entity information 301F.

An example of the billing data 304 generated by the collector program 301C at step S507 is shown in Table V, which continues with the example of the previous tables.

TABLE V

| | | | | Current |
|---|---|---|---|---|
| Entity ID | Entity Name | Entity Address | Entity Acct # | Charges |
| E1 | XYZ Company | Address 1 | 1234 | $10 |
| E2 | LOB X | Address 2 | 2345 | $20 |
| E3 | LOB Y | Address 3 | 3456 | $25 |

The billing data 304 in Table V is simplified for the purpose of clarity. One skilled in the art will appreciate that the billing data 304 may include other information and that the invention is not limited to any particular set of data included in the billing data 304. For example, the billing data 304 may include details about each entity's activity associated with the current charges, such as the total number of messages transmitted during the current billing cycle, total bytes transmitted, or any other information compiled at step S505 from which the entity is charged.

At step S508, the billing information generated at step S507 is outputted, optionally to a billing system 305 for further processing. At step S509, the statistics compiled at step S505 are refreshed (i.e. deleted) so that a new batch of statistics may be compiled for the next event occurrence at step S506. The process then returns to step S504. However, instead of refreshing the compiled statistics by the emitter programs, at step S509, it may be desirable for the collector program to retain the previously compiled statistics, which may be stored in the summary queue 301D.

It should be noted that steps S507 and S508 are optional, and that instead of these steps, the statistics compiled at step S505 may be outputted instead of being used to generate billing data 304 upon occurrence of the event at step S506. Because the compiled statistics are useful by themselves for infrastructure and resource planning, marketing, etc., an embodiment of the invention outputs compiled statistics in lieu of the billing data 304 or in conjunction with the billing data 304. In the case where compiled statistics are outputted, such statistics need not be outputted to a billing system 305 and may be outputted to another system and/or to a computer-accessible memory.

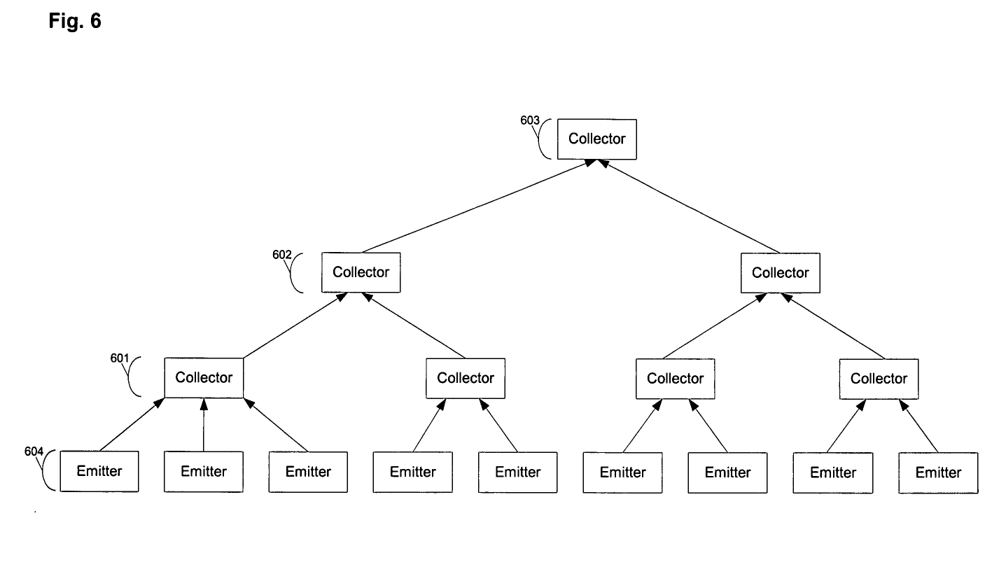

FIG. 6 illustrates an embodiment of the present invention where multiple layers, 601, 602, 603 of collector programs are provided. According to this embodiment, the emitter programs in a layer 604 transmit their summarized statistics to their respectively assigned collector programs in the layer 601. The collector programs in the layer 601 compile the summarized statistics received from their respective emitter programs in the layer 604 and transmit their compiled statistics to their respective collector programs in the next higher layer 602. The collector programs in the layer 602 compile the summarized statistics received from their respective collector programs in the layer 601 and transmit their compiled statistics to the root collector program in the layer 603. The root collector program in the layer 603 compiles the summarized statistics received from the collector programs in the layer 602, and outputs, for example, billing information and/or its overall compiled statistics, as described with reference to FIGS. 5A and 5B. One skilled in the art will appreciate that any number of layers of collector programs may be provided.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A method for measuring usage of a communication-system infrastructure that facilitates transmission of messages between a plurality of computers communicatively connected to the infrastructure via communication channels, the method comprising the steps of:
monitoring a plurality of channels for messages that are transmitted through the plurality of the channels, using a plurality of first programs;
generating, with each of the plurality of first programs, summarized statistics associated with a plurality of messages transmitted through the respectively monitored channels;
transmitting the summarized statistics from each of the first programs to a second program;
compiling the summarized statistics with the second program; and
outputting the compiled statistics.

2. The method of claim 1, further comprising the steps of:
generating billing information based at least upon the compiled statistics, wherein the billing information includes charges associated with an entity that uses the infrastructure; and
outputting the billing information.

3. The method of claim 1, further comprising the step of performing infrastructure planning based at least upon the compiled statistics.

4. The method of claim 1, wherein the summarized statistics include at least one of: a total number of messages transmitted by an entity through the monitored channels, an amount of data transmitted by the entity through the monitored channels, a number of messages transmitted by the entity through the monitored channels that were encrypted, an amount of data transmitted by the entity through the monitored channels that was encrypted, a number of messages transmitted by the entity through the monitored channels that were persistent, an amount of data transmitted by the entity through the monitored channels that was persistent, a number of messages transmitted by the entity through the monitored channels during a predetermined interval, and an amount of data transmitted by the entity through the monitored channels during a predetermined interval.

5. The method of claim 1, wherein the messages are MQ messages.

6. The method of claim 5, wherein the plurality of first programs are input/output callback functions.

7. The method of claim 1, wherein the step of outputting the compiled statistics outputs the compiled statistics to a third program, and wherein the method further comprises the steps of:
generating, with the third program, twice-compiled statistics based at least upon the compiled statistics received from the second program; and
outputting the twice compiled statistics.

8. The method of claim 1, wherein each of the first programs stores its summarized statistics in a local computer-accessible memory and deletes its summarized statistics from its local computer-accessible memory upon transmission of its summarized statistics.

9. A system for measuring usage of a communication-system infrastructure that facilitates transmission of messages between a plurality of computers communicatively connected to the infrastructure via communication channels, the system comprising:
a first computer that executes a first emitter program that causes the first computer to at least (a) monitor a first channel of the communication channels for messages that pass through the first channel, (b) generate first summarized statistics associated with messages transmitted through the first channel, and (c) output the first summarized statistics upon an occurrence of a first event;
a second computer that executes a second emitter program that causes the second computer to at least (a) monitor a second channel of the communication channels for messages that pass through the second channel, (b) generate second summarized statistics associated with messages transmitted through the second channel, and (c) output the second summarized statistics upon an occurrence of a second event; and
a third computer, communicatively connected to the first computer and the second computer, that executes a collector program that causes the third computer to at least compile the first and the second summarized statistics output from the first and the second computers and to output the compiled statistics.

10. The system of claim 9, wherein the third computer functions to generate and output billing information that includes charges associated with an entity that uses the infrastructure.

11. The system of claim 9, further comprising:
an accounting system communicatively connected to the third computer, wherein the third computer functions to generate and output billing information to the accounting system.

12. The system of claim 11, wherein the billing information includes charges associated with an entity that uses the infrastructure.

13. The system of claim 9, wherein the first event and the second event are identical.

14. The system of claim 9, wherein the first event and the second event are different.

15. The system of claim 9, wherein at least one of the first event and the second event is a passage of a predetermined time, an expiration of a predetermined interval, an occurrence of a certain number of messages that pass through the monitored channel, an occurrence of a certain amount of data that passes through the monitored channel, a ceasing of operation of the monitored channel, a receipt of a message prompting transmission of summarized statistics, or an occurrence of a certain number of messages and/or an amount of data that passes through a monitored channel from a particular entity.

16. The system of claim 9, wherein at least one of the first summarized statistics or the second summarized statistics include(s) at least one of: a total number of messages transmitted by an entity through a monitored channel, an amount of data transmitted by an entity through a monitored channel, a number of messages transmitted by an entity through a monitored channel that were encrypted, an amount of data transmitted by an entity through a monitored channel that was encrypted, a number of messages transmitted by an entity through a monitored channel that were persistent, an amount of data transmitted by an entity through a monitored channel that was persistent, a number of messages transmitted by an entity through a monitored channel during a predetermined interval, and an amount of data transmitted by an entity through a monitored channel during a predetermined interval.

17. The system of claim 9, wherein the messages are MQ messages.

18. The system of claim 17, wherein the emitter programs are input/output callback functions.

19. The system of claim 9, further comprising:
a fourth computer communicatively connected to the third computer, wherein the fourth computer executes a collector program that causes the fourth computer at least to receive the compiled statistics outputted by the third computer, generate twice-compiled statistics based at least upon the statistics received from the third computer, and output the twice-compiled statistics.

20. The system of claim 9,
wherein the first program stores the first summarized statistics in a first computer-accessible memory communicatively connected to the first computer,
wherein the first program deletes the first summarized statistics from the first computer-accessible memory upon outputting the first summarized statistics,
wherein the second program stores the second summarized statistics in a second computer-accessible memory communicatively connected to the second computer, and
wherein the second program deletes the second summarized statistics from the second computer-accessible memory upon outputting the second summarized statistics.

21. A method for measuring usage of a communication-system infrastructure that facilitates transmission of MQ messages between a plurality of computers communicatively connected to the infrastructure via communication channels, the method comprising the steps of:
monitoring, with a plurality of first programs, a plurality of communication channels for MQ messages that are transmitted through the plurality of communication channels, wherein the plurality of first programs are input/output callback functions;
generating, with each of the plurality of first programs, summarized statistics associated with a plurality of messages transmitted through respectively monitored channels, wherein each of the first programs stores its summarized statistics in a local computer-accessible memory;
transmitting the summarized statistics from each of the plurality of first programs to a second program, wherein each of the first programs deletes its summarized statistics from its local computer-accessible memory upon transmission of its summarized statistics;
compiling the summarized statistics with the second program;
generating billing information based at least upon the compiled statistics, wherein the billing information includes charges associated with an entity that uses the infrastructure; and
outputting the billing information.
